(19) United States
(12) Patent Application Publication
(10) Pub. No.: US 2016/0226816 A1
(43) Pub. Date: Aug. 4, 2016

(54) CONTROLS FOR RESOLVING PRODUCT AND ACTION DOMAIN NAMES

(71) Applicant: Go Daddy Operating Company, LLC, Scottsdale, AZ (US)

(72) Inventor: Arnold Neil Blinn, Hunts Point, WA (US)

(21) Appl. No.: 14/612,114

(22) Filed: Feb. 2, 2015

(51) Int. Cl. H04L 29/12

(52) U.S. Cl. CPC H04L 61/103; H04L 61/1511; H04L 61/6004

(57) ABSTRACT

Systems and methods for resolving domain names to web content include controls for configuring servers, such as DNS servers, reverse proxy servers, and web servers, to efficiently route resource requests containing domain names in the domains of action gTLDs. The controls implement a domain naming framework that combines domain name labels, such as a SLD with a TLD, to create object+action domain names according to standard domain naming conventions. The SLD may be or match a record in a product identification scheme, which may be a known product identifier for which the web server has and can serve web resource content. A primary DNS server can be configured to route all traffic to the action gTLD, regardless of the content of the SLD, to a particular web server, obviating the need for conventional registration of domain names that use the gTLD.

### FIELD OF THE INVENTION

The present invention generally relates to domain name control systems, and, more specifically, to systems and methods for resolving domain names in a manner that simplifies conventional user input requirements.

### BACKGROUND OF THE INVENTION

For Internet users and businesses alike, the Internet continues to be increasingly valuable. Individuals and businesses depend on their online presences, particularly their websites, to deliver current and useful information to customers, readers, and other Internet users. Websites are made available to visitors online via domain names that the visitors type into Internet browsing software (“web browsers”). A domain name is comprised of at least two labels each separated by a period and including a top-level domain (TLD) as the rightmost label, with a second-level domain (SLD) to the left of the TLD and further subordinate levels, called subdomains, extending to the left. Thus, an example domain name is “blog.example.com,” where “com” is the TLD, “example” is the SLD, and “blog” is a subdomain.

In the Internet user's experience, domain names comprise an addressing system that replaces the internet protocol (IP) addresses of the computer servers (e.g., web servers) that make the websites available. This is preferable because domain names can be more easily remembered than IP addresses, which are, to users, apparently random groups of numbers (IPv4 addresses) or numbers and letters (IPv6 addresses). Domain names are resolved to their associated IP addresses in order to route Internet traffic to the appropriate computer servers. The domain name system (DNS) performs this resolution. The DNS is distributed among DNS servers that handle resolutions in their defined zones of authority. Typically, a zone for DNS purposes corresponds to one label in the domain name: a TLD has a zone and a DNS server that resolves domain names having that TLD; a SLD has a zone and a DNS server that resolves the SLD and subdomains to one or more web servers, or to additional DNS servers as described below. The resolving DNS servers having authority over a zone are known as authoritative nameservers. Each DNS server stores or accesses DNS records, called resource records, that associate each domain name with the IP address of the appropriate computer server, which may be another DNS server, a content server such as a web server or reverse proxy server, or another type of server.

When a user enters a domain name into the web browser, the web browser forms a resource request that is sent into the DNS for resolution by the DNS servers. Appropriate DNS servers that receive the resource request reply to it with the IP address of the next computer in the route. For example, a resource request for the content at domain name best.example.com would start at the authoritative nameserver for “.com,” which would find and return the IP address for the authoritative nameserver for “example.” The requesting device would then send the resource request to the authoritative nameserver for “example,” which would return the appropriate IP address for the “best” subdomain. Once the resource request reaches the IP address of the web server containing the content, the content is returned to the requesting device.

Domain names must be registered by an owner before they can be used as a website address. Registration involves creating resource records on, typically, at least two DNS servers to associate the domain name with the owner's computer server(s). First, a resource record for the SLD is created on one or more authoritative nameservers for the relevant TLD. These nameservers are known as root name servers. The resource record identifies, by IP address, one or more authoritative nameservers for the SLD. Then, a resource record—specifically, an A record in current DNS formatting—may be created on the authoritative nameserver(s) for the SLD. The A record contains the IP address of the web server that serves requested data to the requesting device from the SLD.TLD domain name. Subdomains of the SLD may each have a zone, and would be registered by creating a resource record identifying one or more nameserver(s) for the subdomain. These nameservers are typically subordinate to the authoritative nameserver(s) for the SLD. Additionally or alternatively, subdomains may be registered as A records in the authoritative nameserver(s) for the SLD.

The Internet Corporation for Assigned Names and Numbers (ICANN) approves some Generic Top-Level Domains (gTLD) and delegates the responsibility to a particular organization (a “registry”) for maintaining an authoritative source for the registered domain names on the root nameserver of a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar is the authoritative source for the contact information related to the domain name. Such registries are referred to as “thin” registries.

Most gTLDs are organized through a central domain name Shared Registration System (SRS) based on their TLD. ICANN is now approving many new gTLDs, called gTLD strings, and granting control and administration of the registry of a particular gTLD string via the SRS to a gTLD buyer that can prove its capacity for providing a support framework to implement the registry. The gTLD buyer thus becomes the registry administrator, or registry, of the new gTLD. The number of available gTLDs is now skyrocketing, with over 600 new gTLD strings being approved for launch in the year 2013. Recently launched gTLD strings include: company names, famous product names, cities, and other proper nouns; generic nouns such as “.bank” and “.sport;” internet-related terms such as “.online” and “.network” in various languages; and action verbs such as “.buy.” Use—that is, registration of new domain names thereon—of a gTLD string can be restricted by its registry, and several restriction schemes have arisen based on factors such as sponsorship (i.e., approval by the registry or an authorized private agency), geography, and the like. Registries can also enact routing scheme rules that determine how internet traffic to the gTLD's domain names is handled by the implementing servers, provided the rules conform to ICANN policies. A registry can act as its own registrar, offering domain names on its gTLD for registration by end users, or the registry can authorize additional registrars to manage domain name registration on its gTLD in accordance with rules determined by ICANN and the registry.

While basic domain names can be easy to remember, they typically do not form the complete address to specific resources, known as the uniform resource locator (URL) of a certain web page. Internet users of various sophistication levels have difficulty quickly finding specific resources online using a conventional browser due to the complexity of URLs. The user might type a URL directly into the browser's address bar if the URL is known. Typically, however, a URL for a specific resource, such as a product's purchase or review page, may be extremely long, incomprehensible, non-intuitive, subject to spelling errors, and subject to other drawbacks. For example, a purchase page for the first-edition hardcover version of the book “The Martian” by Andrew Weir, published by Crown, can be found at “http://www.barnesandnoble.com/w/the-martian-andy-weir/114993828?ean=9780804139021,” a URL that no user can be expected to type directly into the address bar. Furthermore, even if a user did know the complete domain name string, the administrator of the associated website may change the web page name or path, rendering the URL useless. It would be advantageous to have a control system for routing internet traffic to domain names based on a derivable combination of an identification scheme for objects with a gTLD string that is a verb describing what the visitor wants to do with the object.

### BRIEF DESCRIPTION OF THE DRAWINGS

FIG. 1 is a schematic diagram of a system in a first operating configuration in accordance with the present disclosure.

FIG. 2 is a schematic diagram of a system in a second operating configuration in accordance with the present disclosure.

FIG. 3 is a schematic diagram of a system in a third operating configuration in accordance with the present disclosure.

FIG. 4 is a schematic diagram of a system in a fourth operating configuration in accordance with the present disclosure.

FIG. 5 is a flow diagram of an embodiment of a method for routing resource requests containing a URL with a product identifier as an SLD and an action verb as a gTLD.

### DETAILED DESCRIPTION OF THE PREFERRED EMBODIMENT

The present invention achieves the aforementioned goals by providing controls for resolving domain names according to a domain naming framework that simplifies the submission of web resource requests by software applications, particularly for web browsing on “conventional” browsers having an address bar into which a user may type the domain name in order to retrieve the desired web resource. The naming framework combines a SLD with a TLD to create object+action domain names according to standard domain naming conventions. The SLD may be or match a record in a product identification scheme, which may be a known product identification scheme (e.g., Universal Product Code (UPC), stock keeping unit (SKU), International Standard Book Number (ISBN)) or a custom identification scheme. The TLD may be a gTLD string that matches a verb corresponding to an action a visitor wishes to perform. Such a TLD is referred to herein as a “verb gTLD.” Thus, the TLD+SLD reflect a verb+object relationship, making the URL easier to remember. The present controls and naming schemes are described with respect to “product.action” domain names, but it will be understood that the controls and schemes may be modified without undue experimentation to accommodate any “object.verb” relationships where the “objects” conform to an identification scheme.

The controls coordinate resolution of the “product.action” domain names to a website or web page containing information or user interfaces that enable the user to perform the action. Thus, for example, a purchase web page for the first-edition hardcover version of the book “The Martian” by Andrew Weir, published by Crown, which book has the ISBN-13 number 9780804139021, may be reached by entering “9780804139021.buy” into the browser address bar; entering “9780804139021.review” into the browser address bar will take the user to a web page containing reviews of the same book and/or an interface enabling the user to submit a review of the book; entering “9780804139021.read” into the browser address bar will take the user to a web page configured to allow the user to read all or a portion of the book.

In one embodiment, the present disclosure provides a system for serving web resource data to a client device. The system includes a first domain name system (DNS) server in electronic communication with the client device via an electronic communication network and configured to receive resource requests containing a uniform resource locator (URL). The URL has a generic top level domain (gTLD) that is associated with an action desired by a user of the client device, and a second level domain (SLD) that identifies an object on which the user desires to perform the action. The system further includes controls implemented on the first DNS server and configuring the first DNS server to, responsive to receiving a resource request containing the SLD and the gTLD from the client device, route the resource request to a first content server. The system further includes controls implemented on the first content server and configuring the first content server to, responsive to receiving the resource request, compare the SLD to a plurality of identifiers in an identification scheme, the identifiers each being associated with a data identifier. The controls further configure the first content server to, responsive to a determination that the SLD matches one of the identifiers, return the web resource data identified by the data identifier associated with the identifier that matches the SLD. The gTLD may be a verb and the SLD may be a noun.

The identification scheme may be a product identification scheme, and the identifiers may be product identifiers. The controls implemented on the first DNS server may include a resource record index containing exactly one routing record, the routing record containing a universal wildcard configuring the first DNS server to route all resource requests containing the gTLD to the first content server. The controls implemented on the first content server may include a routing table associating each of the identifiers with one of the data identifiers. The first content server may be a web server having access to a data store containing the web resource data. The first content server may be a reverse proxy server, and the routing table may associate each of the identifiers with one of a plurality of second content servers. Returning the web resource data may include obtaining the web resource data from the second content server associated with the identifier that matches the SLD.

The controls implemented on the first DNS server may include a resource record index containing a plurality of routing records each containing one of a plurality of partial wildcards, each of the partial wildcards being associated in the routing record with the first content server or another content server. The partial wildcard may be a syntax of a product identification scheme. The partial wildcard may be a partial product identifier combined with a wildcard operator.

In another embodiment, the system for serving web resource data to a client device includes a first domain name system (DNS) server in electronic communication with the client device via an electronic communication network and configured to receive resource requests containing a uniform resource locator (URL), the URL including a generic top level domain (gTLD) that is associated with an action desired by a user of the client device and a second level domain (SLD) that identifies an object on which the user desires to perform the action, and controls implemented on the first DNS server and configuring the first DNS server to, responsive to receiving a resource request containing the SLD and the gTLD from the client device, return to the client device an IP address for a first content server configured to perform the action. The controls may configure the first DNS server to return the IP address for the first content server regardless of the SLD in the URL. The first DNS server may be a root server. The gTLD may be a verb describing the action. The SLD may match one of a plurality of product identifiers in a product identification scheme. The controls may further configure the first DNS server to compare the SLD to one or more partial wildcards, each partial wildcard comprising a portion of one of the product identifiers, and at least one of the partial wildcards being associated with the IP address of the first content server.

A system including the present inventive controls may be implemented in hardware, or in software configuring the hardware, for the particular use of resolving domain name inquiries for a gTLD that is a verb identifying an action to take, referred to herein as an “action gTLD.” The controls may be implemented partially or completely at the DNS level, where DNS servers are configured with the controls. The configured DNS servers may be supported, for domain name resolution and traffic routing purposes, by one or more reverse proxy servers. The controls may further include configurations of one or more web servers that store and serve the requested web resource. The controls may span multiple zones of authority, including across transitions from registry authority to registrar authority. In contrast to known DNS configurations, the DNS servers configured with the present controls do not require “registration” of specific SLDs via entry, for each specific SLD, of A, CNAME, DNAME, and other DNS records into the DNS servers' databases to resolve an input domain name to a web server containing the requested web page. Rather, the DNS servers may operate on partial or full wildcards with respect to the SLD from the primary DNS server down the DNS server hierarchy to the web server. Examples of such wildcard operation are described below and illustrated in the Figures.

The controls are implemented in accordance with one or more product identification schemes. Each product identification scheme identifies products using identifiers that conform to a syntax. The syntax, in turn, cannot violate the rules of domain naming conventions. In particular, an SLD must have at least one and at most 63 characters, which must be alphanumeric and may include the “−” symbol other than at the beginning or end of the SLD. The syntax may require a fixed length of identifier, and may add leading or trailing characters to identifiers that are shorter than the fixed length. Product identification schemes using identifiers over 63 characters are not recommended, but may be used if the identifier can be truncated without compromising its ability to identify a product. Alternatively, identifiers may be split between SLD and subdomain at a suitable position in the identifier; this will accommodate longer identifiers. Shorter identifiers will retain the benefit of being easy to type by a user, but are not essential to the operation of the present systems, as automated URL entry such as hyperlinking, barcode scanning, and other technologies may use the present systems advantageously.

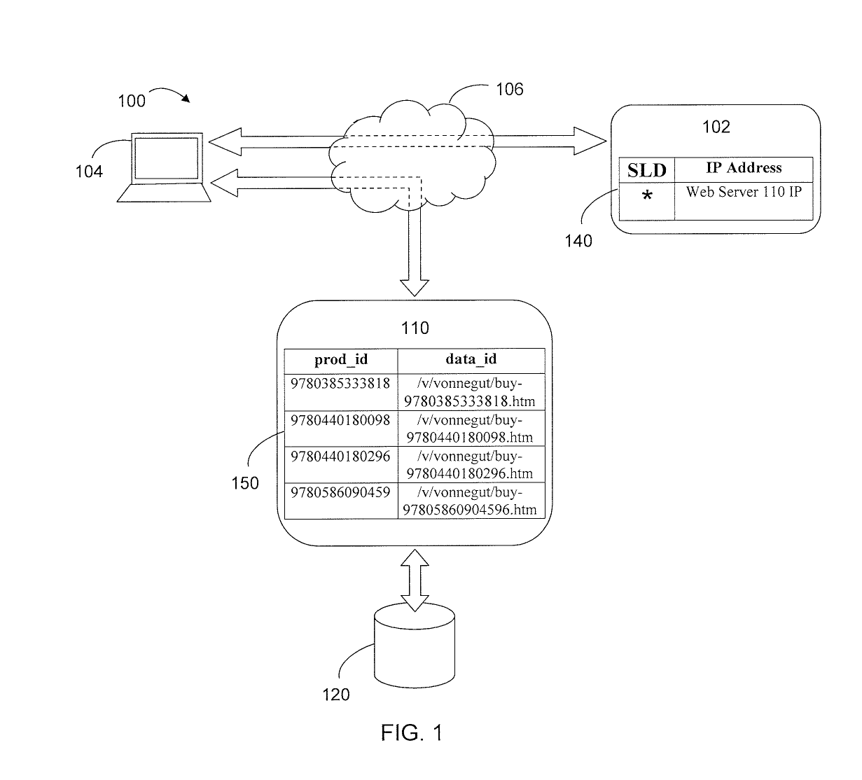

Referring to FIG. 1, a system 100 implementing the present controls may include a primary DNS server 102 for a certain action gTLD. The primary DNS server 102 receives resource requests in the form of a URL from a requesting client device 104 via the internet 106 or another computer network with which the primary DNS server 102 and client device 104 are in communication. The primary DNS server 102 may be a root server of the DNS. The client device 104 may include a browser or other software application that formats the resource request in response to a user input of a URL into the browser, the URL having a product identifier as the SLD and the action gTLD as the TLD. The resource request may contain additional information included in a header of the resource request. The header parameter “Host” is currently required and contains the URL being requested (i.e., the URL typed by the user into the browser). The browser then sends the resource request, which is routed via DNS to the primary DNS server 102 having authority over the action gTLD.

The primary DNS server 102 may be configured to redirect the client device 104 to send the resource request to a web server 110, which has an IP address known to the primary DNS server 102. The web server 110 may be a content server configured to store and/or host and/or serve web resource data, such as website, web page, web application, user interface, and other data, which is to be served to client devices requesting the web resource. The web resource data may be stored in a resource data store 120 that is present on the web server 110 or remote from and accessible by the web server 110. The resource data store 120 may be a database, file system, or other suitable data storage arrangement or device. The web server 110 may additionally or alternatively be a transaction server configured to perform a transaction (e.g., request or process purchasing) on requested products, an inventory server configured to track inventory of the products and return information on the inventory, an application server configured to instantiate or access a web application and deliver application content to the client device, or another server configured to operate on data pertaining to the products.

The controls for the primary DNS server 102 may be implemented via a resource record index 140 stored on the primary DNS server 102. The resource record index 140 may be a database, lookup table, zone file, or other indexing arrangement. The resource record index 140 may include known DNS resource record types adapted for use with the present system. In particular, the resource record index 140 may include one or more entries (i.e., resource records) instructing the primary DNS server 102 to route incoming resource requests containing the action gTLD according to at least the action gTLD. These entries are illustrated in the Figures, but it will be understood that the resource record index 140 may contain other information, such as keywords, parameters, and comments when the resource record index 140 is a zone file. In some embodiments, the resource record index 140 may contain only one resource record, which is an A record or other routing record containing a universal wildcard (represented as * in FIG. 1). The wildcard indicates that all resource requests are to be routed to the same destination, regardless of the characters present in the SLD (i.e., for any character string in the SLD). The destination identified in the routing record may be the IP address of the web server 110. In some embodiments, upon receiving the resource request from the client device 104, the primary DNS server 102 will return the IP address of the web server 110 to the client device 104. The client device 104 then sends the resource request to the web server 110.

The controls for the web server 110 may be implemented via a product routing table 150 stored on the web server 110. The product routing table 150 may be a database, lookup table, zone file, or other indexing arrangement associating each product identifier (“prod_id”) in the product identification scheme with a data identifier (“data_id”) representing the web resource data to be served in response to a request for the prod_id. The data_id may be a file name (e.g., a web page file name such as “prod_id.htm”), file system path or partial path, function call, or other suitable resource identifier as is known in the art of serving web content in response to HTTP requests. The web server 110 may be configured to obtain the SLD, such as by extracting the SLD from the “Host” element of the resource request header. The web server 110 then matches the SLD to a prod_id in the product routing table 150 and serves the associated web resource data to the client device 104 as is known in the art. In some embodiments, the web server 110 is configured for use with the “product.action” configuration of incoming requests and the web resource data served to the client device 104 allows the user to perform the desired action on the requested product.

In another embodiment, the controls may configure the web server 110 to identify the requested web resource data without looking up the product identifier in a product routing table 150. Instead, the data identifiers (e.g., file name) for each element of the web resource data may follow a known format that includes the product identifier. For example, the format for data identifiers may be “product.htm?id=<prod_id>” and the web server 110 may be configured to retrieve the web resource data for the produce identifier “ABC1234” at file location “product. htm?id=ABC1234.”

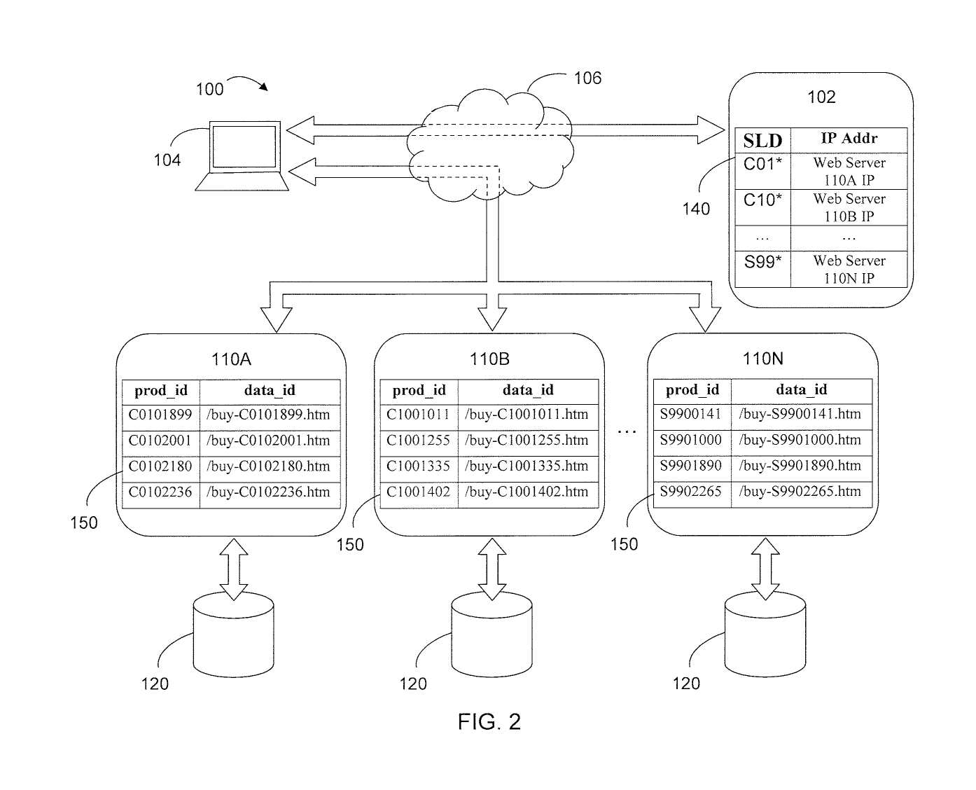

Referring to FIG. 2, the controls may configure the primary DNS server 102 to route resource requests (i.e., “traffic” to the action gTLD) to a plurality of web servers 110A, 110B, . . . , 110N using multiple routing records in the resource record index 140. In some embodiments, each routing record in the resource record index 140 may be a “partial wildcard” that includes one or more wildcard operators attached to a partial product identifier. Additionally or alternatively, the partial wildcard may be a regular expression containing the partial product identifier. In some embodiments, the partial product identifier may be a substring of the product identifier that identifies a subset of the products. A simple, non-limiting example of forming a partial wildcard (illustrated in FIG. 2) in an online department store's product identification scheme includes appending the wildcard operator to the first three characters of the product identifier, which represent the product's department (e.g., men's clothing, women's clothing, sporting goods, furniture, etc.). In an example for a known standardized scheme, a 13-digit ISBN has five parts: a three-digit prefix, followed by a two-digit registration group element, followed by a four-digit registrant (e.g., publisher) element, followed by a three-digit publication (e.g., title) element, followed by a checksum character. Any of the parts of the ISBN may be a partial product identifier. In another example, each web server 110A-N is owned and/or operated by a different company, and the partial product identifier serves to differentiate resource requests between the companies and route the resource requests to the appropriate company's web server 110A-N.

In other embodiments, the partial wildcard may identify the product identification scheme itself, apart from other product identifications schemes. The system 100 may thus resolve requests for products in different schemes, allowing the registry to provide registry services to a plurality of entities (e.g., registrars, competing businesses) that wish to host web resource data at the action gTLD. In some embodiments, the partial wildcard may be a syntax matcher that analyzes the SLD of the resource request to determine which of a plurality of product identification schemes the SLD (i.e., product identifier) belongs to. The syntax matcher may be distinguishable from a partial product identifier in that the syntax matcher checks the entire SLD for conformance to a set of formatting requirements, while a partial product identifier is a known substring in a known position within the SLD. Non-limiting examples of formatting requirements include: fixed length of product identifier; suitable characters within product identifier; and substring parameters such as required starting or ending character(s) (e.g., “identifier starts with letters N, Z, or 5”), substring position and/or contents (e.g., “first three characters are alpha characters, followed by a dash”), and any other suitable formatting requirement that can be used to set the syntax of a product identification scheme. The formatting requirements for the syntax of ISBN-13, for example, are: identifier is 13 characters; all characters are Arabic numerals (i.e., 0-9); and, as of 2015, the first three digits are either 978 or 979 (a fourth requirement, which is a check digit calculation, may be checked by the syntax matcher but would only be needed to differentiate from another product identification scheme that would meet the first three ISBN-13 formatting requirements in some cases). The controls may configure the primary DNS server 102 to apply the syntax matcher using a pattern mask for each syntax, the pattern mask embodying the formatting requirements for one of the product identification schemes. Additionally or alternatively, the partial wildcard may include a partial product identifier, which alone may identify the appropriate product identification scheme.

The resource record index 140 may include routing records that route the traffic according to a match of either or both of the syntax and the partial product identifier in the partial wildcard. Thus, a resource record index 140 for routing traffic based on book publisher may contain, for example, four-character partial product identifiers each corresponding to the registrant element of a subset of ISBN-13s, and each being associated with the IP address of one of the web servers 110A-N. The controls may configure the primary DNS server 102 to match the partial wildcard expression having the format “[5]XXXX*” against an incoming SLD to determine the applicable routing record as follows: ignore the first five characters of the SLD; match the substring of the next four characters XXXX, representing the registrant element of the ISBN-13, against the routing records; ignore the remaining characters of the SLD. The primary DNS server 102 then may return the IP address of the web server 110A-N identified in the matching routing record to the client device 104. The receiving web server 110A-N then may process the resource request as described above with respect to FIG. 1.

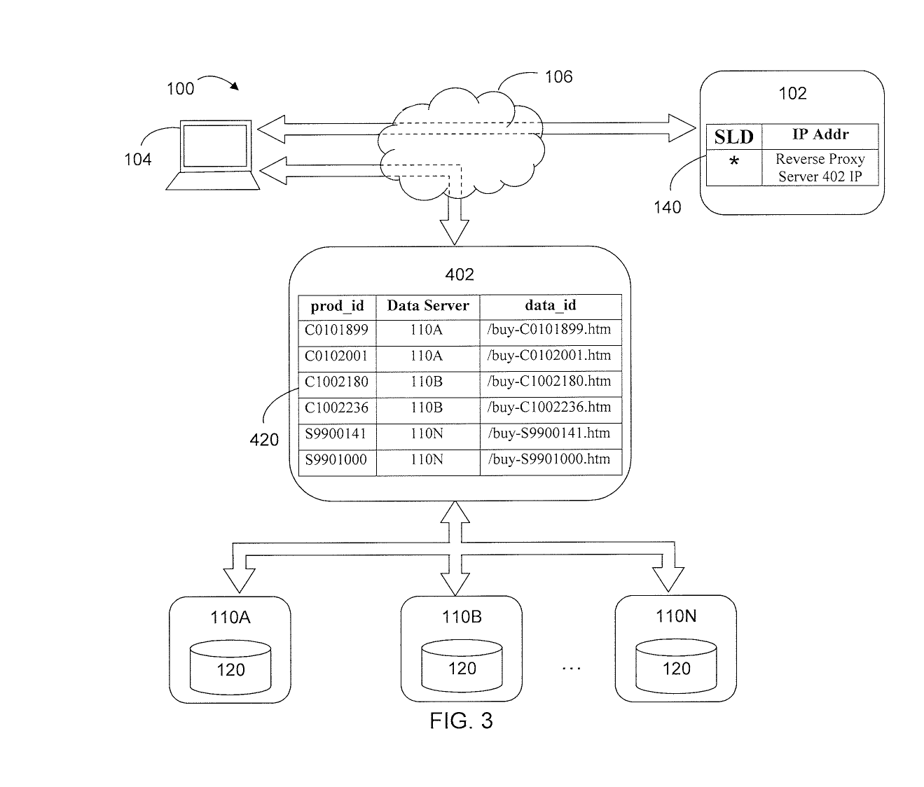

Referring to FIG. 3, the controls of the system 100 may configure the primary DNS server 102 to route action gTLD traffic to one or more reverse proxy servers 402, rather than directly to the web servers 110A-N. As shown in FIG. 3, the primary DNS server 102 may be configured as described with respect to FIG. 1 to route resource requests via universal wildcard to a single reverse proxy server 402. In other embodiments, such as when the system 100 handles action gTLD traffic for multiple product identification schemes, the primary DNS server 102 may be configured as described with respect to FIG. 2 to route requests to multiple reverse proxy servers 402 via partial wildcard matching. The primary DNS server 102 returns the IP address of the reverse proxy server 402 to the client device 104, which then submits the resource request to the reverse proxy server 402. The reverse proxy server 402 in turn identifies the SLD and determines which of the web servers 110A-N contains the requested web resource data, obtains the requested web resource data from the appropriate web server 110A-N, and serves the web resource data to the client device 104. Thus, the reserve proxy server 402 acts as a content server for delivering the requested content to the client device 104. Additionally or alternatively, the reverse proxy server 402 may serve as a web cache for web resource data previously served by the web servers 110A-N, and may cache and serve static or dynamic content as is known in the art.

The controls for the reverse proxy server 402 may be implemented via a server routing table 420 stored on the reverse proxy server 402. In some embodiments, the server routing table 420 may contain sufficient information to identify the web server 110A-N as well as the web resource data to be served in response to the request, thus eliminating the need for the web server 110A-N to identify the requested web resource data (e.g., via lookup in the product routing table 150 of FIG. 1). The server routing table 420 may be a database, lookup table, or other indexing arrangement associating each product identifier (“prod_id”) in the product identification scheme with a web server 110A-N IP address and a data identifier (“data_id”) representing the web resource data to be served in response to a request for the prod_id. In other embodiments, the server routing table 420 may contain data lookup records including the web server 110A-N IP address for each product identifier or a subset thereof, as described above. In such embodiments, the reverse proxy server 420 may provide the prod_id to the appropriate web server 110A-N when requesting the web resource data, and the web server 110A-N may identify and retrieve the web resource data using the product routing table 150 as described above. In still other embodiments, the reverse proxy server may route traffic to the web servers 110A-N for purposes of load balancing, as is known in the art.

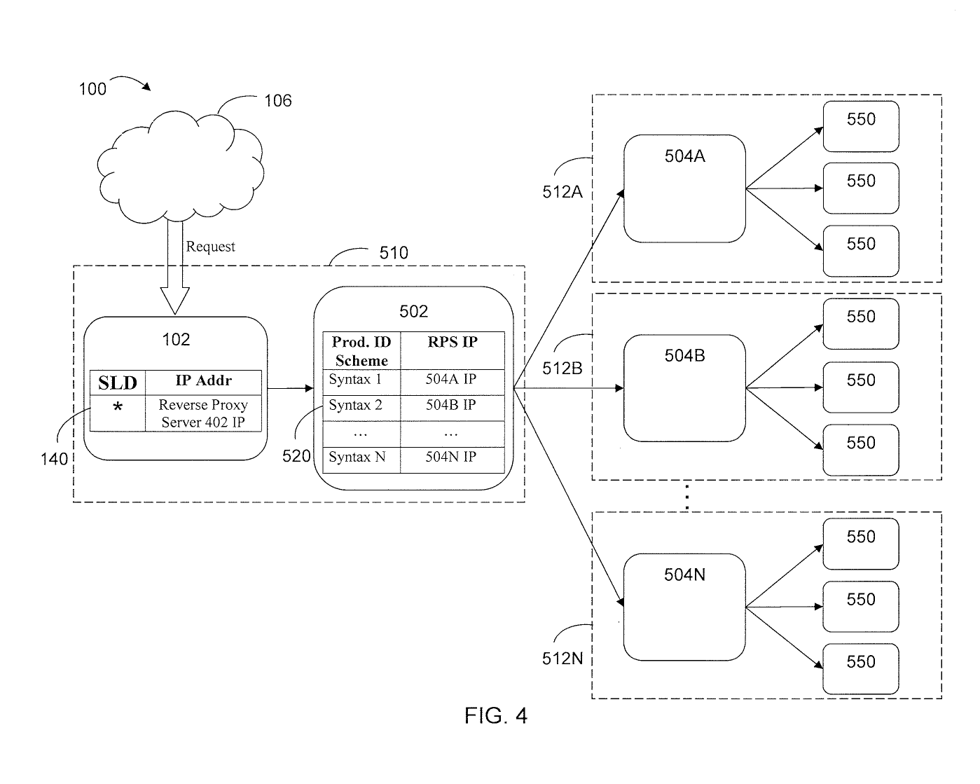

In some embodiments, the primary DNS server 102 (or a sub-level DNS server 302A-N according to the implementations described above) may identify the product identification scheme using syntax matching or partial product identifier(s), and may route the request to the appropriate reverse proxy server 402, which may be controlled by an entity other than the entity controlling the primary DNS server 102, such as a company serving web resource data or providing other services related to the action gTLD. Additionally or alternatively, as shown in FIG. 4, the primary DNS server 102 may route all action gTLD traffic (using the universal wildcard as in the resource record index 140 of FIG. 1) to a primary reverse proxy server 502 under control of the registry (delineated by the administrative zone of authority 510). The primary reverse proxy server 502 may be configured with a server routing table 520 associating each product identification scheme (e.g., via syntax) with a sub-level reverse proxy server 504A, 504B, . . . , 504N, each under control of the entity using the associated product identification scheme (delineated by zones of authority 512A, 512B, . . . , 512N). The sub-level reverse proxy servers 504A-N identify and retrieve web resource data from web servers 550 in control of the respective registrars as described above.

In any of the control schemes described above, one or more of the DNS servers, reverse proxy servers, and web servers involved in serving a resource request may validate the SLD as a product identifier according to the server's access to product information and desired level of validation. A basic validation may be a comparison of the SLD to a syntax of the product identification scheme; the validating server routes the request to the next level if the SLD meets the formatting requirements. A full validation may be a comparison of the SLD to a list of product identifiers; the validating server routes the request to the next level if the SLD matches a product identifier in the list.

Any suitable network topology may be used to facilitate data transfer and interfaces between the client device 104, DNS and reverse proxy servers, and web servers 110A-N. The servers may be configured to communicate electronically with each other and with one or more temporary or permanently implemented data stores containing data. The electronic communication may be over the Internet using any suitable electronic communication medium, communication protocol, and computer software including, without limitation: a wired connection, WiFi or other wireless network, cellular network, or satellite network; TCP/IP or another open or encrypted protocol; browser software, application programming interfaces, middleware, or dedicated software programs. The electronic communication may be over another type of network, such as an intranet, local area network, or virtual private network, or may be via direct wired communication interfaces or any other suitable interface for transmitting data electronically from a data store to the server. In some embodiments, a data store may be a component of the server, such as by being contained in a memory module or on a disk drive of the server.

A data store may be any repository of information that is or can be made freely or securely accessible by the server. Suitable data stores include, without limitation: databases or database systems, which may be a local database, online database, desktop database, server-side database, relational database, hierarchical database, network database, object database, object-relational database, associative database, concept-oriented database, entity-attribute-value database, multi-dimensional database, semi-structured database, star schema database, XML or JSON data object database, file, collection of files, spreadsheet, or other means of data storage located on a computer, client, server, or any other storage device known in the art or developed in the future; file systems; and electronic files such as web pages, spreadsheets, and documents.

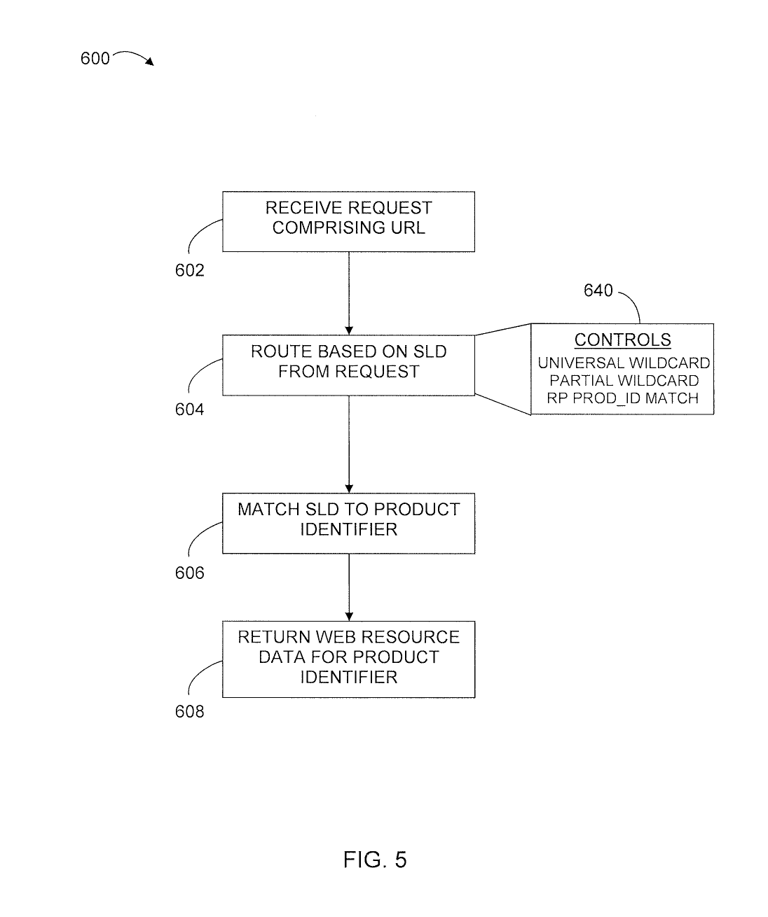

Referring to FIG. 5, the present systems may be implemented to perform a method 600 for routing resource requests containing a URL, where the URL has an SLD that is a noun (e.g., a product identifier in a product identification scheme), and a gTLD that is a verb (e.g., an action verb), without requiring that the URL be fully registered in a DNS server (i.e., there is no A record for the complete URL). At step 602, a server of the system receives the resource request comprising the URL. At step 604, the server routes the request based on the SLD of the URL. To route the request, the server may utilize any of the controls 640 described above, including a universal wildcard that routes all requests to a particular server, a partial wildcard that matches the SLD to a known syntax for a product identification scheme or to a partial product identifier identifying a subset of the products in the product identification scheme, or a full product identifier match (e.g., by a reverse proxy server) to the SLD. At step 606, a server (typically a different server) to which the request is routed may match the SLD to a product identifier in the product identification scheme. At step 608, the server may return the web resource data for the matched product identifier to the requesting device.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention has been described in terms of one or more preferred embodiments, and it should be appreciated that many equivalents, alternatives, variations, and modifications, aside from those expressly stated, are possible and within the scope of the invention.

What is claimed is:

1. A system for serving web resource data to a client device, the system comprising:
a first domain name system (DNS) server in electronic communication with the client device via an electronic communication network and configured to receive resource requests containing a uniform resource locator (URL),
the URL comprising a generic top level domain (gTLD) that is associated with an action desired by a user of the client device,
the URL further comprising a second level domain (SLD) that identifies an object on which the user desires to perform the action;
controls implemented on the first DNS server and configuring the first DNS server to, responsive to receiving a resource request containing the SLD and the gTLD from the client device, route the resource request to a first content server; and
controls implemented on the first content server and configuring the first content server to, responsive to receiving the resource request:
compare the SLD to a plurality of identifiers in an identification scheme, the identifiers each being associated with a data identifier; and
responsive to a determination that the SLD matches one of the identifiers, return the web resource data identified by the data identifier associated with the identifier that matches the SLD.

2. The system of claim 1, wherein the gTLD is a verb.

3. The system of claim 2, wherein the SLD is a noun.

4. The system of claim 1, wherein the identification scheme is a product identification scheme, and wherein the identifiers are product identifiers.

5. The system of claim 1, wherein the controls implemented on the first DNS server comprise a resource record index containing exactly one routing record, the routing record comprising a universal wildcard configuring the first DNS server to route all resource requests containing the gTLD to the first content server.

6. The system of claim 5, wherein the controls implemented on the first content server comprise a routing table associating each of the identifiers with one of the data identifiers.

7. The system of claim 6, wherein the first content server is a web server having access to a data store containing the web resource data.

8. The system of claim 6, wherein the first content server is a reverse proxy server, and wherein the routing table further associates each of the identifiers with one of a plurality of second content servers.

9. The system of claim 8, wherein returning the web resource data comprises obtaining the web resource data from the second content server associated with the identifier that matches the SLD.

10. The system of claim 1, wherein the controls implemented on the first DNS server comprise a resource record index containing a plurality of routing records each comprising one of a plurality of partial wildcards, each of the partial wildcards being associated in the routing record with the first content server or another content server.

11. The system of claim 10, wherein the partial wildcard is a syntax of a product identification scheme.

12. The system of claim 10, wherein the partial wildcard is a partial product identifier combined with a wildcard operator.

13. A system for serving web resource data to a client device, the system comprising:
a first domain name system (DNS) server in electronic communication with the client device via an electronic communication network and configured to receive resource requests containing a uniform resource locator (URL),
the URL comprising a generic top level domain (gTLD) that is associated with an action desired by a user of the client device,
the URL further comprising a second level domain (SLD) that identifies an object on which the user desires to perform the action; and
controls implemented on the first DNS server and configuring the first DNS server to, responsive to receiving a resource request containing the SLD and the gTLD from the client device, return to the client device an IP address for a first content server configured to perform the action.

14. The system of claim 13, wherein the controls configure the first DNS server to return the IP address for the first content server regardless of the SLD in the URL.

15. The system of claim 13, wherein the first DNS server is a root server.

16. The system of claim 13, wherein the gTLD is a verb describing the action.

17. The system of claim 13, wherein the SLD matches one of a plurality of product identifiers in a product identification scheme.

18. The system of claim 17, wherein the controls further configure the first DNS server to compare the SLD to one or more partial wildcards, each partial wildcard comprising a portion of one of the product identifiers, and at least one of the partial wildcards being associated with the IP address of the first content server.
